(19) United States
(12) Patent Application Publication
(10) Pub. No.: US 2015/0045055 A1
(43) Pub. Date: Feb. 12, 2015

(54) TIME OF FLIGHT RESPONDERS

(71) Applicants: Gaby Prechner, Rishon Lezion (IL); Leor Banin, Petach Tikva (IL); Yuval Amizur, Kfar-Saba (IL); Uri Schatzberg, kiryat ono (IL)

(72) Inventors: Gaby Prechner, Rishon Lezion (IL); Leor Banin, Petach Tikva (IL); Yuval Amizur, Kfar-Saba (IL); Uri Schatzberg, kiryat ono (IL)

(21) Appl. No.: 14/100,925

(22) Filed: Dec. 9, 2013

Related U.S. Application Data
(60) Provisional application No. 61/862,708, filed on Aug. 6, 2013.

(51) Int. Cl. H04W 64/00

(52) U.S. Cl. CPC H04W 64/00
USPC 455/456.1

(57) ABSTRACT

Apparatus and techniques are described, such as for providing indoor location services. Embodiments include active, passive or independent time-of-flight (ToF) responders that are adapted to provide a device with fine time measurement information to a device in order to determine a distance between the device and the network equipment or a responder. Embodiments may include network equipment coupled to one or more active ToF responders such that the active ToF responders provides ToF information to a device when the network equipment does not support a ToF protocol. Embodiments may include a server coupled to the network equipment, the server being arranged to receive location information from a plurality of devices over a network connection provided by an access point other than the network equipment, and to determine the location of the network equipment and one or more ToF responders coupled to the network equipment based on the location information.

### CLAIM OF PRIORITY

This patent application claims the benefit of priority to U.S. Provisional Patent Application Ser. No. 61/862,708, entitled “TIME OF FLIGHT RESPONDERS,” filed on Aug. 6, 2013, (Attorney Docket No. 884.P02PRV), which is hereby incorporated by reference herein in its entirety.

### TECHNICAL FIELD

Embodiments pertain to wireless communications. Some embodiments relate to indoor navigation. Some embodiments relate to systems and methods for time-of-flight responders.

### BACKGROUND

Outdoor navigation is widely available thanks to the development of various global navigation satellite systems (GNSS) such as GPS, GLONASS and GALILEO. However the field of indoor navigation is not as developed. This field differs from the outdoor navigation due to the fact that the indoor environment generally limits or prevents the reception of signals from GNSS satellites. As a result, a need exists to provide an indoor navigation solution that is scalable and includes satisfactory precision.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is an illustration of an example configuration of a communication network architecture, in accordance with some embodiments;

FIG. 2 is a block diagram of an example wireless communication system, in accordance with some embodiments;

FIG. 3 depicts an example of a communication system with an access point and passive repeaters, in accordance with some embodiments;

FIG. 4 depicts an example of a communication system with an access point and active extenders, in accordance with some embodiments;

FIG. 5A depicts an example of a communication system with an access point, passive repeaters, and active extenders, in accordance with some embodiments;

FIG. 5B is a flowchart illustrating an example method for automatically determining a location of a ToF responder, in accordance with some embodiments;

FIG. 6 illustrates a functional block diagram of a mobile device, in accordance with some embodiments;

FIG. 7 is a block diagram illustrating a mobile device in accordance with some embodiments; and

FIG. 8 illustrates a block diagram of an example machine upon which any one or more of the techniques (e.g., methodologies) discussed herein may be performed.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A time of fight (ToF) method of location may be defined as the overall time that a signal propagates from a device to an access point (AP) and back to the device. This value may be converted into a distance value by dividing the propagation time by two, and multiplying that result by the speed of light. This method is robust and scalable, but generally involves hardware changes to existing access points (e.g., Wi-Fi modems or switches).

Embodiments of the systems, techniques and devices discussed herein may provide an accurate indoor location mechanism utilizing ToF calculations in locations where there may be inadequate deployment of access points for accurate ToF indoor location. For example, in locations where there is a reduced need for multiple access points but there is a need for accurate indoor location (e.g., parking lots, big box stores, grocery stores, etc.), or a location with an existing AP deployment that doesn't support ToF location calculations. These embodiments may also be utilized to promote a ToF ecosystem during the early stages of indoor location adoption. For example, a deployment a ToF solution that is not dependent on a single manufacturer or vendor of one or more access points. In this manner, the issues aforementioned may be addressed without the cost of a full or large scale deployment of expensive access points, which may include the cost of new access point hardware, deployment (e.g., setup, wiring, power, etc.), maintenance, and other expenses.

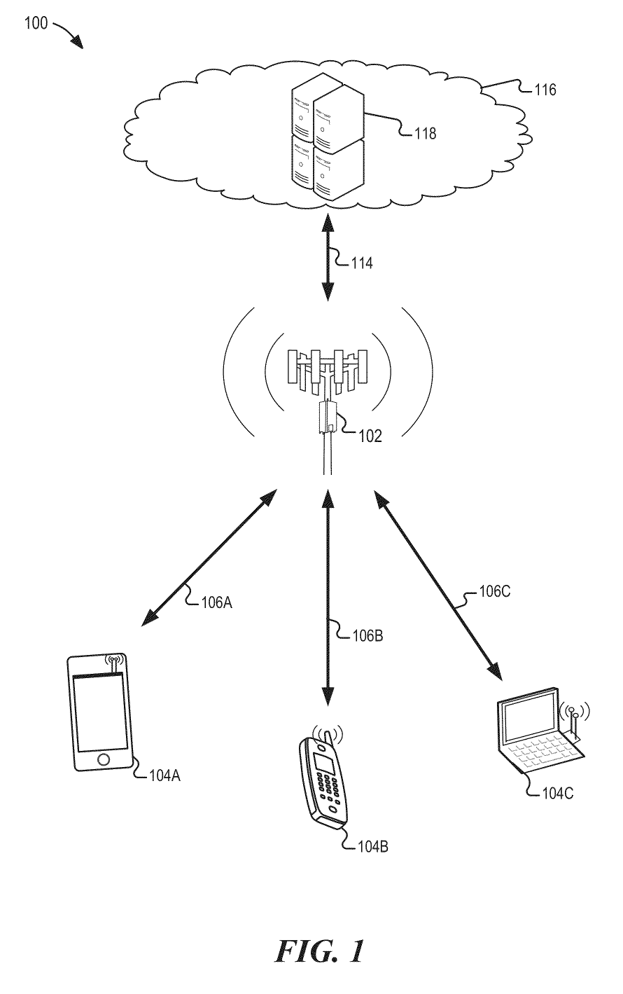

FIG. 1 provides an illustration of an example configuration of a communication network architecture 100. Within the communication network architecture 100, a carrier-based network such as an IEEE 802.11 compatible wireless access point or a LTE/LTE-A cell network operating according to a standard from a 3GPP standards family is established by network equipment 102. The network equipment 102 may include a wireless access point, a Wi-Fi hotspot, or an enhanced or evolved node B (eNodeB) communicating with communication devices 104A, 104B, 104C (e.g., a user equipment (UE) or a communication station (STA)). The carrier-based network includes wireless network connections 106A, 106B, and 106C with the communication devices 104A, 104B, and 104C, respectively. The communication devices 104A, 104B, 104C are illustrated as conforming to a variety of form factors, including a smartphone, a mobile phone handset, and a personal computer having an integrated or external wireless network communication device.

The network equipment 102 is illustrated in FIG. 1 as being connected via a network connection 114 to network servers 118 in a cloud network 116. The servers 118 may operate to provide various types of information to, or receive information from, communication devices 104A, 104B, 104C, including device location, user profiles, user information, web sites, e-mail, and the like. The techniques described herein enable the determination of the location of the various communication devices 104A, 104B, 104C, with respect to the network equipment 102.

Communication devices 104A, 104B, 104C may communicate with the network equipment 102 when in range or otherwise in proximity for wireless communications. As illustrated, the connection 106A may be established between the mobile device 104A (e.g., a smartphone) and the network equipment 102; the connection 106B may be established between the mobile device 104B (e.g., a mobile phone) and the network equipment 102; and the connection 106C may be established between the mobile device 104C (e.g., a personal computer) and the network equipment 102.

The wireless communications 106A, 106B, 106C between devices 104A, 104B, 104C may utilize a Wi-Fi or IEEE 802.11 standard protocol, or a protocol such as the current 3rd Generation Partnership Project (3GPP) long term evolution (LTE) time division duplex (TDD)-Advanced systems. In an embodiment, the communications network 116 and network equipment 102 comprises an evolved universal terrestrial radio access network (EUTRAN) using the 3rd Generation Partnership Project (3GPP) long term evolution (LTE) standard and operating in time division duplexing (TDD) mode. The devices 104A, 104B, 104C may include one or more antennas, receivers, transmitters, or transceivers that are configured to utilize a Wi-Fi or IEEE 802.11 standard protocol, or a protocol such as 3GPP, LTE, or TDD-Advanced or any combination of these or other communications standards.

Antennas in or on devices 104A, 104B, 104C may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to utilize spatial diversity and the different channel characteristics that may result between each of the antennas and the antennas of a transmitting station. In some MIMO embodiments, antennas may be separated by up to 1/10 of a wavelength or more.

In some embodiments, the mobile device 104A may include one or more of a keyboard, a display, a non-volatile memory port, multiple antennas, a graphics processor, an application processor, speakers, and other mobile device elements. The display may be an LCD screen including a touch screen. The mobile device 104B may be similar to mobile device 104A, but does not need to be identical. The mobile device 104C may include some or all of the features, components, or functionality described with respect to mobile device 104A.

A base station, such as an enhanced or evolved node B (eNodeB), may provide wireless communication services to communication devices, such as device 104A. While the exemplary communication system 100 of FIG. 1 depicts only three devices users 104A, 104B, 104C any combination of multiple users, devices, servers and the like may be coupled to network equipment 102 in various embodiments. For example, three or more users located in a venue, such as a building, campus, mall area, or other area, and may utilize any number of mobile wireless-enabled computing devices to independently communicate with network equipment 102. Similarly, communication system 100 may include more than one network equipment 102. For example, a plurality of access points or base stations may form an overlapping coverage area where devices may communicate with at least two instances of network equipment 102.

Although communication system 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of system 100 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, system 100 may include one or more processors and may be configured with instructions stored on a computer-readable storage device.

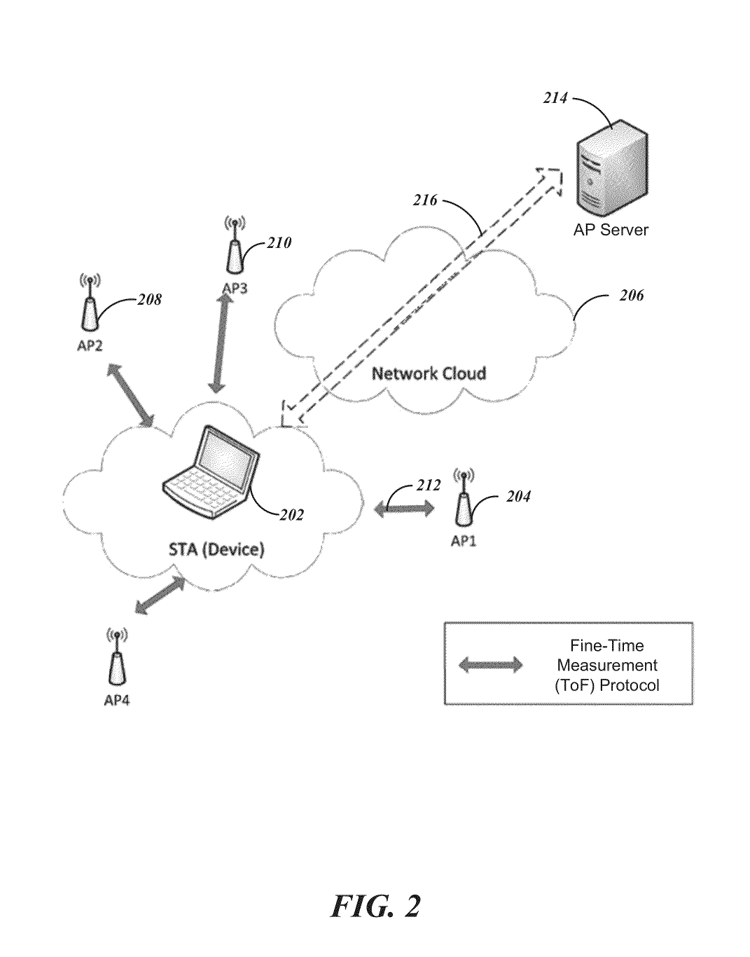

FIG. 2 is a block diagram of an example wireless communication system 200 that may utilize the communication network architecture 100 of FIG. 1. The exemplary communication system 200 may include a device 202 that is capable of wireless communication (e.g., a user equipment (UE) or communication station (STA)). In an example, the device 202 may be a mobile computing device such as a cellular phone, a smartphone, a laptop, a tablet computer, a personal digital assistant or other electronic device capable of wireless communication. A first access point (AP) 204 may, for example, be a base station or a fixed wireless router. The device 202 may establish a communication link 212 with the first access point 204 in order to reach a network 206 such as the Internet. In an example, the device 202 may communicate with an access point server 214 via a connection 216, for example, through the first access point 204 and the network 206. The connection 216 may be unencrypted or, for example, be encrypted and utilize HyperText Transfer Protocol Secured (HTTPS) and transport layer security (TLS) to prevent the interception or unauthorized manipulation of data exchanged between the device 202 and the access point server 214.

In an example, a second access point 208 or a third access point 210 may be within range of the device 202. The device 202 may communicate with the first access point 204, the second access point 208 or the third access point 210. The device 202 may request location information regarding one or more of the first access point 204, the second access point 208, the third access point 210, or any other access point, from the access point server 214. In response to the location information request, the secure access point locations server 214 may provide the device 202, via connection 216, with the location information corresponding to the requested access point. In an example, the access point server 214 may also provide the device 202 with one or more keys that the device 202 may utilize to securely communicate with the requested access point.

The first access point 204, the second access point 208, and the third access point 210 may all provide timing and/or location information to the device 202 over a secure communication link that may be established using a key, or other security information obtained by the device 202, from the access point server 214. The timing information may include time-of-arrival or time-of-departure data with respect to the TOF protocol exchange that are local to the each access point. The location information may include an updated location of a respective access point.

The first access point 204, the second access point 208, and the third access point 210 may be or include extenders to an AP, which may be referred to herein as ToF responders, may enable a device to perform ToF location through the use of only a single AP and its corresponding extenders. In an example, ToF responders may be less expensive than a full featured AP and may be more compact and easier to deploy. ToF responders may include a variety of embodiments, for example, passive ToF responders, active ToF responders, or independent ToF responders.

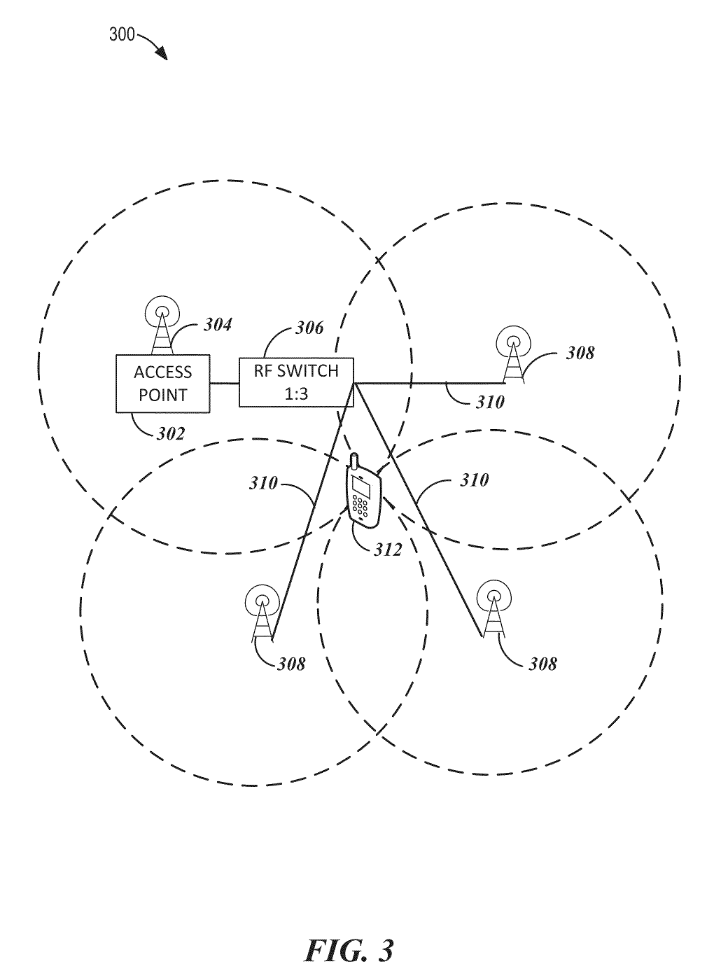

FIG. 3 depicts an example indoor location system 300 with an access point 302 and passive ToF Responders, in accordance with some embodiments. The access point 302 may include one or more antenna 304 and be coupled or connected to an RF Switch 306. The RF Switch 306 may be connected to a plurality of antennas 308 by individual RF cables 310. The plurality of antennas 308 may be positioned at equal distances from the access point 302, or at individual distances around the access point 302. The location and placement of the antennas 308 may be determined, for example, by the physical environment (e.g., walls, ceilings, cable routing areas) where the access point 302 is located.

For example, each antenna 308 may include a passive ToF responder that may be utilized with access point 302 such that multiple antennas adjacent to the single access point 302 provide a greater coverage area that would be possible with just the access point 302. In this example, the only hardware needed to extend an existing access point installation is the RF switch 306 and a number RF cables corresponding to each one of the antennas 308. Additional antennas 308 may be distributed at equal or varying distances from the access point 302 and RF switch 306. The antennas 308 may be positioned at a uniform or variable minimum distance from the access point 302. For example, antennas 308 may each be disposed at a fixed distance, or a variety of distances, between five and one-hundred meters from the access point 302.

The access point 302, may be adapted to perform ToF procedures, and may utilize time sharing techniques (e.g., a round-robin equal division of time) between all of the antennas 308 thereby creating multiple virtual access points in multiple different locations, or an expanded area around the access point 302. The multiple virtual access points may include networking capabilities, or be limited to only performing ToF procedures or other distance measurements, or individually arranged in order to provide any combination of services. In the example depicted in FIG. 3 where the access point 302 and the three virtual access points (i.e., antennas 308) generally surround a device 312, the device 312 may interact with the access point 302 through its local antenna 304 as well as the antennas 308 connected to the access point 302 to determine the location of device 312.

In an example, when the device 312 requests a fine time measurement (FTM) procedure, the access point 302 and antennas 308 answer the device 312 at intervals (e.g., time sliced or multiplexed communication) when each individual antenna 308 or antenna 304 will be in a listening mode. The location of each antenna 308 may be determined by the access point 302, or manually arranged at the access point 302, such that the device 312 will receive enough information to perform the FTM procedure with the access point 302 through antenna 304 and antennas 308. In an example, the device 312 will receive data needed for location calculation by the device 312. In an example, the access point may determine the location of device 312 based on data received at antenna 304 and antennas 308 to provide the device 312 with its location.

Although the passive responder embodiment depicted in FIG. 3 may be of lower cost and easier to deploy than alternative configurations, the access point 302 supports the ToF service such that existing access points that do not include ToF capabilities would potentially need to be replaced; and, because all of the antenna 308 share the same resources of access point 302 the number of potential clients that an access point 302 can service decreases with the addition of more antennas 308.

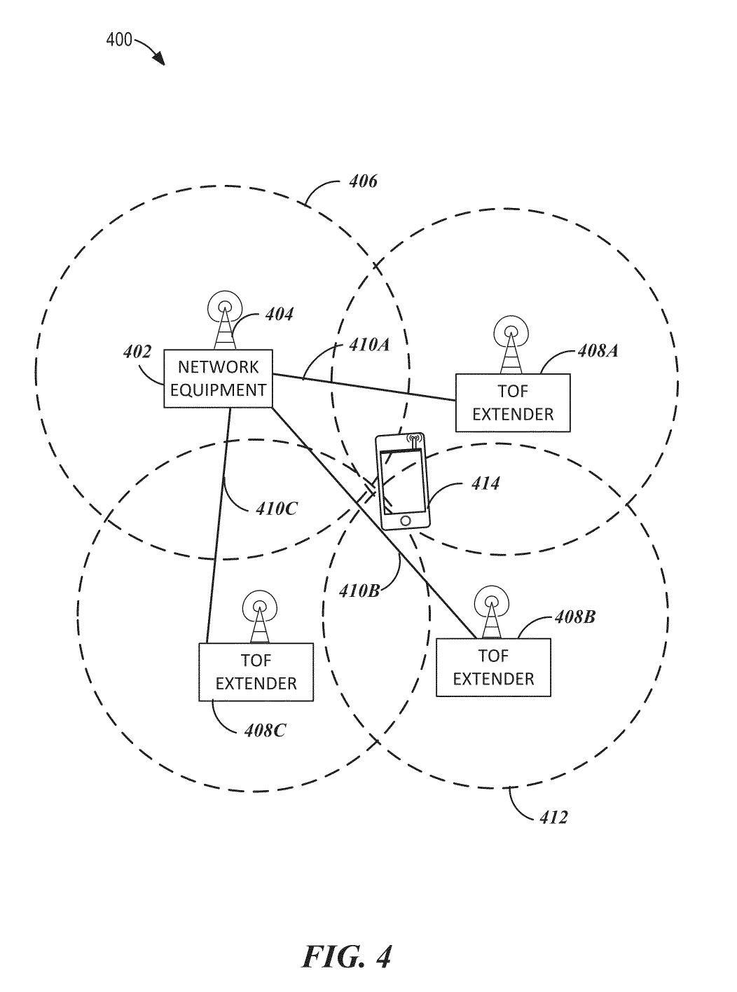

FIG. 4 depicts an example of a communication system 400 including a network equipment 402 (e.g., an access point, a Wi-Fi modem, etc.) and a plurality of active ToF responders (408A, 408B, 408C), in accordance with some embodiments. In an example, each of the active ToF responder (408A, 408B, 408C) includes communication hardware that has the ability to perform a ToF protocol exchange (e.g., a fine time measurement (FTM) procedure). The active ToF responders (408A, 408B, 408C) may individually include, but do not need to include, all of the capabilities of the network equipment 402, thereby potentially reducing the size and cost of the active ToF responder.

For example, the communication hardware may be arranged to utilize a Wi-Fi protocol (e.g., one of the IEEE 802.11 standards). The active ToF responders (408A, 408B, 408C) may be used, in addition to performing ToF as a responder, be controlled wirelessly by the network equipment 402 the responder is extending. For example, connections (410A, 410B, 410C) may be wired or wireless connections.

As depicted in FIG. 4, some advantages of the active ToF responders have over alternative configurations may include, for example, an active ToF responder may be very low cost and easy to deploy as no network connection is needed (e.g., only a power source is needed for the responder); the primary access point that is being extended (e.g., network equipment 402) does not need to support ToF protocols; or the number of client devices (e.g., device 414) that the primary access point can serve will not be limited as in the passive ToF responder approach depicted in FIG. 3.

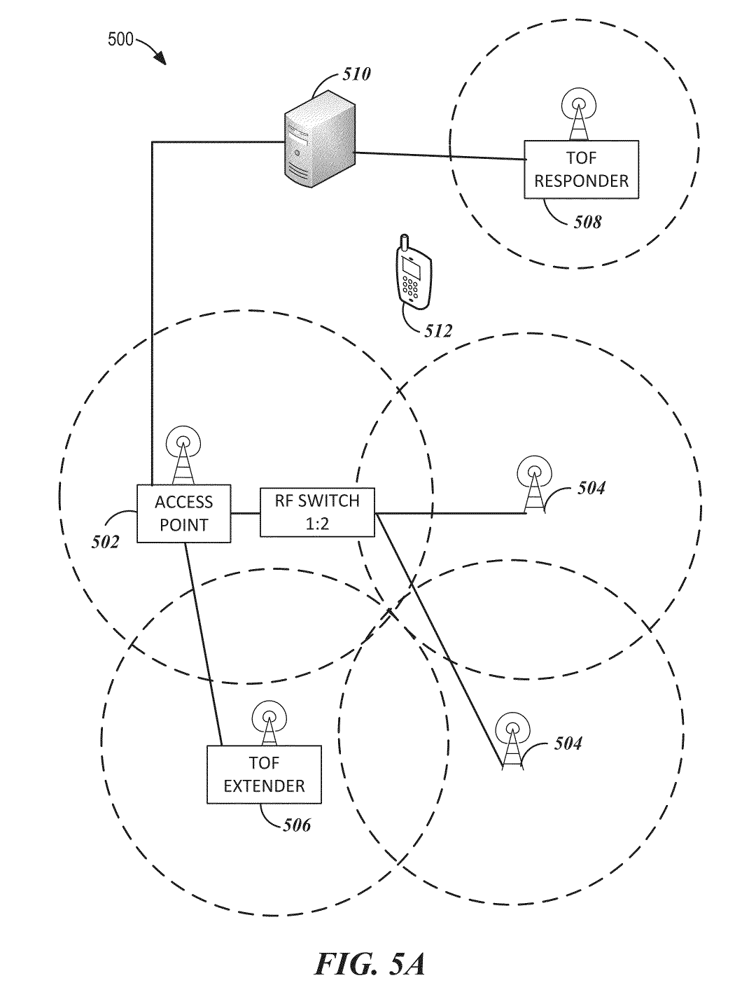

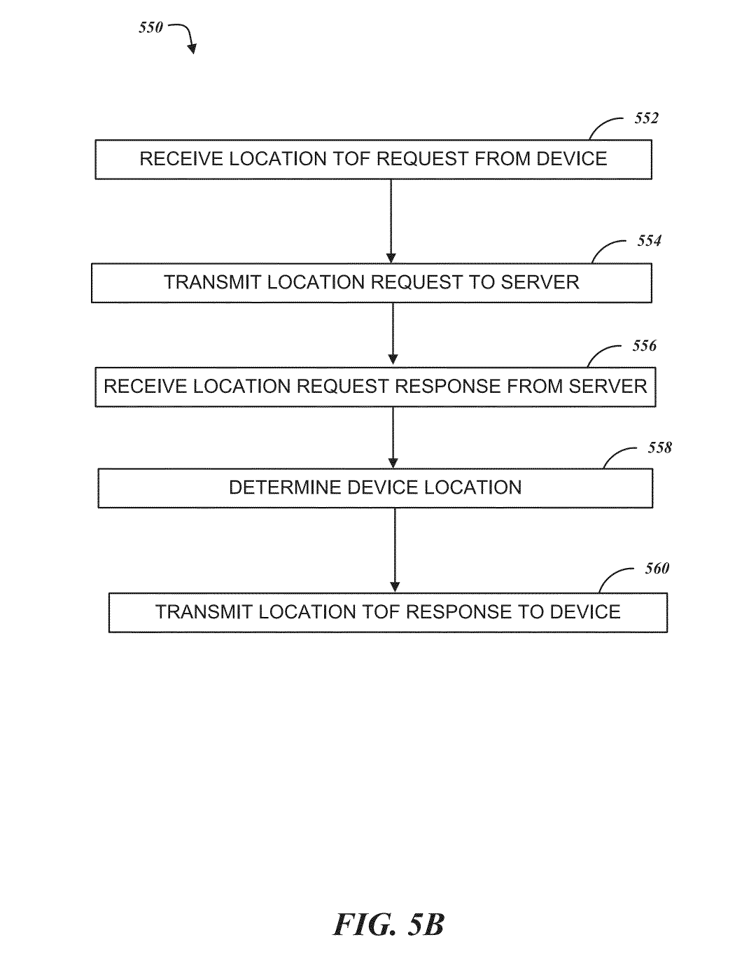

FIG. 5A depicts an example of a communication system 500 with an access point 502, passive repeaters 504, and one or more active extenders 506, in accordance with some embodiments. In an example, one or more independent ToF responders 508 may also be utilized independently of the access point 502 through the use of a crowd-sourcing capability. For example, the communication system 500 may include a fixed ToF responder 508 at a centralized location. The fixed ToF responder may not have its specific location information configured. In this example an installation of the responder does not require the location of the responder to be precisely determined, and may be performed without any special skills or information.

In an example, a server 510 (e.g., access point server 214 of FIG. 2) may be connected to the ToF responder 508 and the access point 502, and configured collect measurement from one or more devices 512 that interact with the fixed ToF responder 508 and thereby determine a position of the fixed ToF responder 508 without any user intervention. The device 512 may access the server 510 a network (e.g., the Internet) through any available wireless connection such as a WiFi or cellular network (3G, 4G, LTE, etc.). The ToF responder 508 itself does not need to serve as internet infrastructure that provides a connection between the server 510 and the device 512.

In an example, a receiver adapted to implement indoor location techniques may be part of a portable wireless communication device (e.g., device 512), such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

FIG. 5B is a flowchart illustrating an example method 550 for automatically determining a location of a ToF responder in accordance with some embodiments. In an example, the method 550 may be performed by the ToF responder 508 of FIG. 5A.

At 552, a network equipment (e.g., ToF responder 508) may receive a location ToF request from device (e.g., device 512 of FIG. 5A). The location ToF request may include an exchange of packets or messages to measure or calculate a distance between the device and the network equipment. In response to receiving the location ToF request, the network equipment may, at 554, transmit a location request to server (e.g., server 510). The location request may include the distance determined by the network equipment during the exchange. The location request may include a request for the location of the network equipment.

At 556, the network equipment may receive a location request response from server. The location request response may include the location of the device, the location of the network equipment, or a combination of both, or any additional information that may assist the network equipment in locating the device or establishing a secure connection between the device and the network equipment. At 558, the network equipment may definitively determine the location of the device, based at least in part on information received by the network equipment from the server. At 560, the network equipment may transmit a location ToF response to device that includes the location of the device

Though arranged serially in the example of FIG. 5B, other examples may reorder the operations, omit one or more operations, and/or execute two or more operations in parallel using multiple processors or a single processor organized as two or more virtual machines or sub-processors. Moreover, still other examples may implement the operations as one or more specific interconnected hardware or integrated circuit modules with related control and data signals communicated between and through the modules. Thus, any process flow is applicable to software, firmware, hardware, and hybrid implementations.

Although the preceding examples indicated the use of device-to-device communications in connection with 3GPP and 802.11 standard communications, it will be understood that a variety of other communication standards capable of facilitating device-to-device, machine-to-machine, and P2P communications may be used in connection with the presently described techniques. These standards include, but are not limited to, standards from 3GPP (e.g., LTE, LTE-A, HSPA+, UMTS), IEEE 802.11 (e.g., 802.11a, 802.11b, 802.11g, 802.11n, 802.11ac), 802.16 (e.g., 802.16p), or Bluetooth (e.g., Bluetooth 4.0, or other standard defined by the Bluetooth Special Interest Group) standards families. Bluetooth, as used herein, may refer to a short-range digital communication protocol defined by the Bluetooth Special Interest Group, the protocol including a short-haul wireless protocol frequency-hopping spread-spectrum (FHSS) communication technique operating in the 2.4 GHz spectrum.

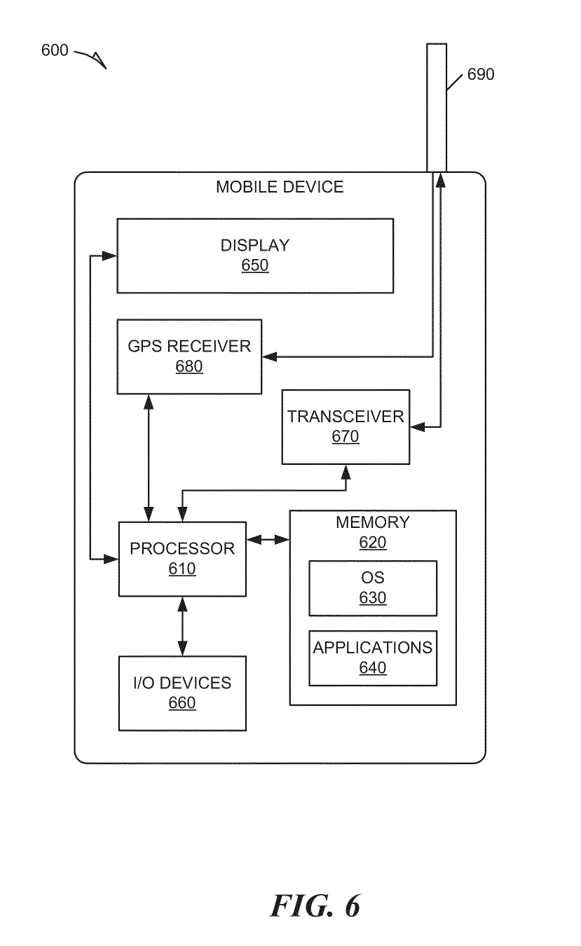

FIG. 6 is a block diagram illustrating a mobile device 600, upon which any one or more of the techniques (e.g., methodologies) discussed herein may be performed. The mobile device 600 may include a processor 610. The processor 610 may be any of a variety of different types of commercially available processors suitable for mobile devices, for example, an XScale architecture microprocessor, a Microprocessor without Interlocked Pipeline Stages (MIPS) architecture processor, or another type of processor. A memory 620, such as a Random Access Memory (RAM), a Flash memory, or other type of memory, is typically accessible to the processor 610. The memory 620 may be adapted to store an operating system (OS) 630, as well as application programs 640. The OS 630 or application programs 640 may include instructions stored on a computer readable medium (e.g., memory 620) that may cause the processor 610 of the mobile device 600 to perform any one or more of the techniques discussed herein. The processor 610 may be coupled, either directly or via appropriate intermediary hardware, to a display 650 and to one or more input/output (I/O) devices 660, such as a keypad, a touch panel sensor, a microphone, etc. Similarly, in an example embodiment, the processor 610 may be coupled to a transceiver 670 that interfaces with an antenna 690. The transceiver 670 may be configured to both transmit and receive cellular network signals, wireless data signals, or other types of signals via the antenna 690, depending on the nature of the mobile device 600. Further, in some configurations, a GPS receiver 680 may also make use of the antenna 690 to receive GPS signals.

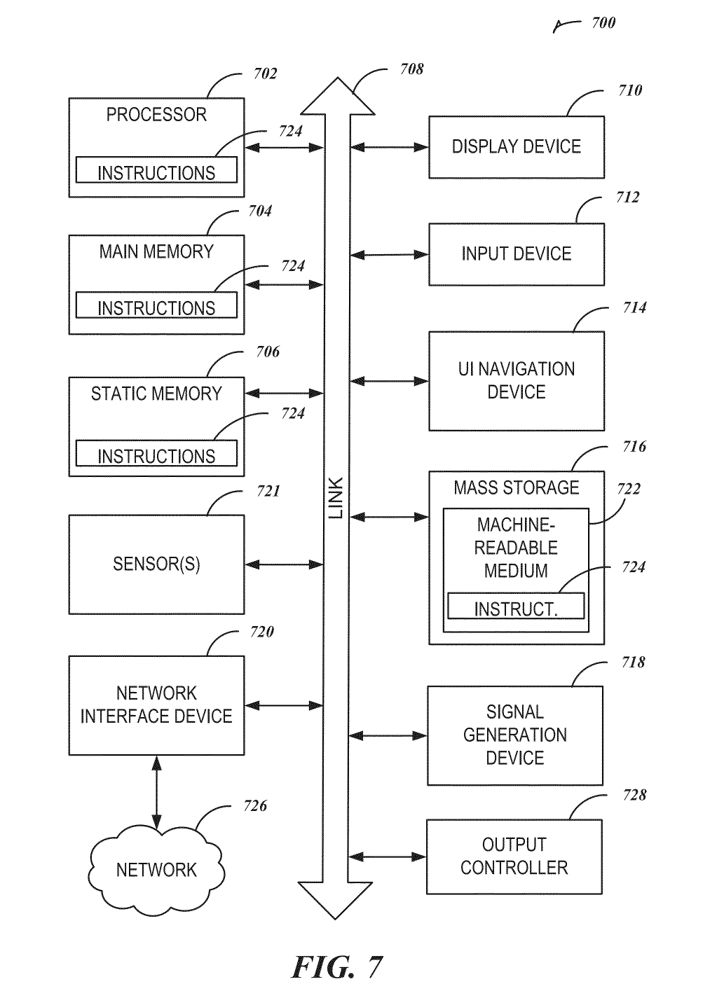

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines or devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured or arranged as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a processing unit, a graphics processing unit (GPU), a hardware processor core, or any combination thereof), a main memory 704, and a static memory 706, some or all of which may communicate with each other via a link 708 (e.g., a bus, link, interconnect, or the like). The machine 700 may further include a display device 710, an input device 712 (e.g., a keyboard), and a user interface (UI) navigation device 714 (e.g., a mouse). In an example, the display device 710, input device 712, and UI navigation device 714 may be a touch screen display. The machine 700 may additionally include a mass storage (e.g., drive unit) 716, a signal generation device 718 (e.g., a speaker or LED), a network interface device 720, and one or more sensors 721, such as a global positioning system (GPS) sensor, camera, video recorder, compass, accelerometer, or other sensor. The machine 700 may include an output controller 728, such as a serial (e.g., universal serial bus (USB), parallel, or other wired or wireless (e.g., infrared (IR)) connection to communicate or control one or more peripheral devices (e.g., a printer, card reader, etc.).

The mass storage 716 may include a machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the mass storage 716 may constitute machine-readable media.

While the machine-readable medium 722 is illustrated as a single medium, the term “machine readable medium” may include a single medium or multiple media (e.g., a centralized or distributed database, and/or associated caches and servers) that configured to store the one or more instructions 724.

The term “machine-readable medium” may include any tangible medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). The term “transmission medium” shall be taken to include any intangible medium that is capable of storing, encoding or carrying instructions for execution by the machine 700, and includes digital or analog communications signals or other intangible medium to facilitate communication of such software.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

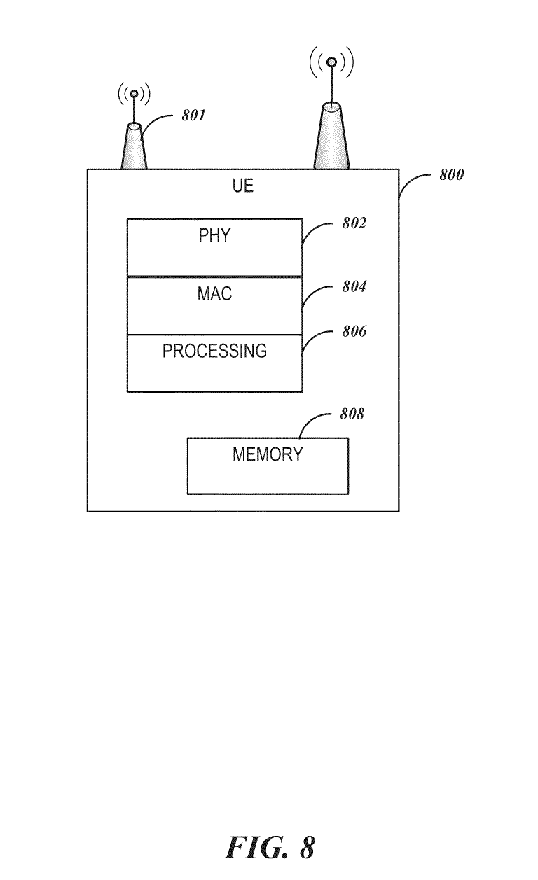

FIG. 8 illustrates a functional block diagram of a UE 800 in accordance with some embodiments. The UE 800 may include physical layer circuitry 802 for transmitting and receiving signals to and from eNBs using one or more antennas 801. UE 800 may also include processing circuitry 806 that may include, among other things a channel estimator. UE 800 may also include a memory 808. The processing circuitry may be configured to determine several different feedback values discussed below for transmission to the eNB. The processing circuitry may also include a media access control (MAC) layer 804.

In some embodiments, the UE 800 may include one or more of a keyboard, a display, a non-volatile memory port, multiple antennas, a graphics processor, an application processor, speakers, and other mobile device elements. The display may be an LCD screen including a touch screen.

The one or more antennas 801 utilized by the UE 800 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated to take advantage of spatial diversity and the different channel characteristics that may result between each of antennas and the antennas of a transmitting station. In some MIMO embodiments, the antennas may be separated by up to 1/10 of a wavelength or more.

Although the UE 800 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage medium, which may be read and executed by at least one processor to perform the operations described herein. A computer-readable storage medium may include any non-transitory mechanism for storing information in a form readable by a machine (e.g., a computer). For example, a computer-readable storage medium may include read-only memory (ROM), random-access memory (RAM), magnetic disk storage media, optical storage media, flash-memory devices, and other storage devices and media. In these embodiments, one or more processors of the UE 800 may be configured with the instructions to perform the operations described herein.

In some embodiments, the UE 800 may be configured to receive OFDM communication signals over a multicarrier communication channel in accordance with an OFDMA communication technique. The OFDM signals may comprise a plurality of orthogonal subcarriers. In some broadband multicarrier embodiments, eNBs (including macro eNB and pico eNBs) may be part of a broadband wireless access (BWA) network communication network, such as a Worldwide Interoperability for Microwave Access (WiMAX) communication network or a 3rd Generation Partnership Project (3GPP) Universal Terrestrial Radio Access Network (UTRAN) Long-Term-Evolution (LTE) or a Long-Term-Evolution (LTE) communication network, although the scope of the inventive subject matter described herein is not limited in this respect. In these broadband multicarrier embodiments, the UE 800 and the eNBs may be configured to communicate in accordance with an orthogonal frequency division multiple access (OFDMA) technique. The UTRAN LTE standards include the 3rd Generation Partnership Project (3GPP) standards for UTRAN-LTE, release 8, Mar. 2008, and release 10, Dec. 2010, including variations and evolutions thereof.

In some LTE embodiments, the basic unit of the wireless resource is the Physical Resource Block (PRB). The PRB may comprise 12 sub-carriers in the frequency domain×0.5 ms in the time domain. The PRBs may be allocated in pairs (in the time domain). In these embodiments, the PRB may comprise a plurality of resource elements (REs). A RE may comprise one sub-carrier x one symbol.

Two types of reference signals may be transmitted by an eNB including demodulation reference signals (DM-RS), channel state information reference signals (CIS-RS) and/or a common reference signal (CRS). The DM-RS may be used by the UE for data demodulation. The reference signals may be transmitted in predetermined PRBs.

In some embodiments, the OFDMA technique may be either a frequency domain duplexing (FDD) technique that uses different uplink and downlink spectrum or a time-domain duplexing (TDD) technique that uses the same spectrum for uplink and downlink.

In some other embodiments, the UE 800 and the eNBs may be configured to communicate signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, the UE 800 may be part of a portable wireless communication device, such as a PDA, a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some LTE embodiments, the UE 800 may calculate several different feedback values which may be used to perform channel adaption for closed-loop spatial multiplexing transmission mode. These feedback values may include a channel-quality indicator (CQI), a rank indicator (RI) and a precoding matrix indicator (PMI). By the CQI, the transmitter selects one of several modulation alphabets and code rate combinations. The RI informs the transmitter about the number of useful transmission layers for the current MIMO channel, and the PMI indicates the codebook index of the precoding matrix (depending on the number of transmit antennas) that is applied at the transmitter. The code rate used by the eNB may be based on the CQI. The PMI may be a vector that is calculated by the UE and reported to the eNB. In some embodiments, the UE may transmit a physical uplink control channel (PUCCH) of format 2, 2a or 2b containing the CQI/PMI or RI.

In these embodiments, the CQI may be an indication of the downlink mobile radio channel quality as experienced by the UE 800. The CQI allows the UE 800 to propose to an eNB an optimum modulation scheme and coding rate to use for a given radio link quality so that the resulting transport block error rate would not exceed a certain value, such as 10%. In some embodiments, the UE may report a wideband CQI value which refers to the channel quality of the system bandwidth. The UE may also report a sub-band CQI value per sub-band of a certain number of resource blocks which may be configured by higher layers. The full set of sub-bands may cover the system bandwidth. In case of spatial multiplexing, a CQI per code word may be reported.

In some embodiments, the PMI may indicate an optimum precoding matrix to be used by the eNB for a given radio condition. The PMI value refers to the codebook table. The network configures the number of resource blocks that are represented by a PMI report. In some embodiments, to cover the system bandwidth, multiple PMI reports may be provided. PMI reports may also be provided for closed loop spatial multiplexing, multi-user MIMO and closed-loop rank 1 precoding MIMO modes.

In some cooperating multipoint (CoMP) embodiments, the network may be configured for joint transmissions to a UE in which two or more cooperating/coordinating points, such as remote-radio heads (RRHs) transmit jointly. In these embodiments, the joint transmissions may be MIMO transmissions and the cooperating points are configured to perform joint beamforming.

The example embodiments discussed herein may be utilized by wireless network access providers of all types including, but not limited to, mobile broadband providers looking to increase cellular offload ratios for cost-avoidance and performance gains, fixed broadband providers looking to extend their coverage footprint outside of customers' homes or businesses, wireless network access providers looking to monetize access networks via access consumers or venue owners, public venues looking to provide wireless network (e.g., Internet) access, or digital services (e.g. location services, advertisements, entertainment, etc.) over a wireless network, and business, educational or non-profit enterprises that desire to simplify guest Internet access or Bring-Your-Own-Device (BYOD) access.

Although systems discussed herein may have several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of system may refer to one or more processes operating on one or more processing elements.

What is claimed is:

1. A network equipment apparatus comprising:
processing circuitry; and
a radio-frequency switch coupled to the processing circuitry;
wherein the processing circuitry is arranged to provide time-of-flight location data to a communication station (STA) by manipulating the radio-frequency switch to periodically select individual passive time-of-flight (ToF) responders from a plurality of passive ToF responders coupled to the radio-frequency switch that are a minimum distance from the network equipment, and to exchange information with the STA or at least some of the passive ToF responders.

2. The network equipment apparatus of claim 1, wherein the processing circuitry is further arranged to calculate a location of the STA based at least in part on the exchanged information, and provide the STA with the location.

3. The network equipment apparatus of claim 1, wherein the network equipment is disposed at least at the minimum distance from the plurality of passive ToF responders.

4. The network equipment apparatus of claim 1, wherein the network equipment is disposed at the minimum distance from each one of the plurality of passive ToF responders.

5. The network equipment apparatus of claim 1, wherein the processing circuitry is further arranged to establish a wireless connection between the transceiver and the STA at least in part by performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

6. The network equipment apparatus of claim 1, wherein the minimum distance is at least three meters and less than twenty meters.

7. The network equipment apparatus of claim 1, wherein the minimum distance is at least twenty meters and less than one-hundred meters.

8. The network equipment apparatus of claim 1, wherein the radio-frequency switch is a separate from the processing circuitry and antenna, and coupled to the processing circuitry by a cable.

9. A fine-time-measurement location system comprising:
a network equipment apparatus coupled to a network, the network equipment apparatus including:
processing circuitry;
an antenna; and
a transceiver coupled to the processing circuitry and the antenna;
wherein the processing circuitry is arranged to provide time-of-flight location data to a device by exchanging information with the device; and
a plurality of time-of-flight (ToF) responders communicatively coupled to the network equipment apparatus, each one of the plurality of ToF responders including:
a processor and memory coupled to the processor;
a local transceiver coupled to the processor and the local antenna;
wherein the processor is arranged to provide localized time-of-flight location data to the device by exchanging information with the device;
wherein the network equipment receives the localized time-of-flight location data from each one of the plurality of the ToF responders.

10. The system of claim 9, wherein the plurality of the ToF responders are each disposed at a minimum distance from the network equipment apparatus.

11. The system of claim 9, wherein the plurality of the ToF responders are each disposed at different minimum distances from the network equipment apparatus.

12. The system of claim 9, further comprising:
a server coupled to the network equipment apparatus through the network, the server arranged to receive ToF measurement data from a plurality of communication stations (STAs), and based at least in part on the received ToF measurement data, determine a location of the network equipment apparatus and a position of each one of the ToF responders.

13. The system of claim 12, wherein the device accesses the network through a connection with the network equipment apparatus.

14. The system of claim 13, wherein the plurality of ToF responders cannot provide a network connection to the server.

15. The system of claim 12, wherein the device accesses the network through a connection with one of the plurality of ToF responders.

16. The system of claim 12, wherein the device accesses the network through a network connection provided by an access point other than the ToF responder and the network equipment.

17. The system of claim 12, wherein the network equipment apparatus is arranged to establish a network connection with the device, and connect the device to the network.

18. The system of claim 16, wherein the network connection includes a wireless network connection performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

19. A non-transitory machine-readable medium having machine-readable code stored thereon for causing a network equipment to execute a method comprising:
manipulating a radio-frequency switch of the network equipment to periodically select an individual time-of-flight (ToF) responder from a plurality of ToF responders coupled to the radio-frequency switch that are a minimum distance from the network equipment;
receiving a location ToF request at the network equipment from a device;
providing time-of-flight location data to the device;
exchanging information with the device through an antenna of the network equipment or at least a portion of the plurality of ToF responders;
determining a location of the device; and
transmitting a location ToF response to the device, the location ToF response including the location of the device.

20. The non-transitory machine-readable medium of claim 19, wherein receiving the location time-of-flight (ToF) request at the network equipment from the device includes exchanging a plurality of packets between the device and the network equipment; and
the method further comprises: determining, by the network equipment, a distance between the device and the network device based at least in part on the exchange;
wherein the location request includes the distance between the device and the network device.

21. The non-transitory machine-readable medium of claim 19, wherein the method further comprises establishing a wireless connection between the network equipment and the device at least in part by performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.
